(19) United States
(12) Patent Application Publication
(10) Pub. No.: US 2008/0225313 A1
(43) Pub. Date: Sep. 18, 2008

(54) IMAGE PROCESSING APPARATUS AND METHOD AND COMPUTER-READABLE RECORDING MEDIUM HAVING STORED THEREIN THE PROGRAM

(75) Inventor: Yoshiro IMAI, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/046,181

(22) Filed: Mar. 11, 2008

(30) Foreign Application Priority Data
Mar. 12, 2007 (JP) 2007-061300

(51) Int. Cl. H04N 1/60

(52) U.S. Cl. 358/1.9; 358/1.1

(57) ABSTRACT

When image processing is performed on image data representing an image to obtain processed image data, an image processing condition setting unit calculates a recommended correction amount for compressing the dynamic range of the image. Further, a display unit displays information representing the recommended correction amount.

### BACKGROUND OF THE INVENTION

1. Field of the Invention

The present invention relates to an image processing apparatus and method for performing assisting (supplementary) operation to determine a correction amount of the dynamic range of an image when image processing is performed to compress the dynamic range of the image. Further, the present invention relates to a program for causing a computer to execute the image processing method.

2. Description of the Related Art

Conventionally, images obtained by taking pictures of a subject with a photography apparatus, such as a digital camera, and images obtained by photoelectrically reading out images recorded on photograph film, such as negative film and reversal film, printed materials or the like have been reproduced at a reproduction apparatus, such as a printer. When the images are reproduced at the reproduction apparatus, the dynamic ranges of the images are compressed so that the dynamic ranges of the images are within the dynamic range of the reproduction apparatus. The dynamic ranges are compressed in such a manner that loss of gradation in highlights of the images (formation of white areas in which gradation (or detail) is lost by so-called “Shiro-Tobi” in Japanese) and/or loss of gradation in shadows of the images (formation of black areas in which gradation (or detail) is lost by so-called “Kuro-Tsubure” in Japanese) are prevented.

For example, a method for performing image processing including dynamic range compression has been proposed (please refer to Japanese Unexamined Patent Publication No. 11(1999)-191871). In the method, image processing is performed on an image by automatically setting, based on a photography condition at the time of obtainment of the image, a correction amount of the density or color of the image and a correction amount of the dynamic range of the image in an appropriate manner.

However, the qualities of images required or desired by users differ depending on the tastes of the users. Therefore, if the correction amount is automatically set to perform image processing on an image, the quality of the image does not always satisfy the users. In the method disclosed in Japanese Unexamined Patent Publication No. 11(1999)-191871, an image obtained by performing image processing using a determined correction amount is displayed. Then, the density of the whole image, the density of each color, gradation, highlights and shadows of the processed image are adjusted by using an adjustment key that has been set at a keyboard of a personal computer. Accordingly, it is possible to obtain an image having a quality desired by the user.

However, compared with correction of the color and density of an image, it is particularly difficult to set an appropriate adjustment amount to regenerate gradation in highlights and shadows of the image. Therefore, a user needs to repeat adjustment of a correction amount of the dynamic range of the image, looking at the image, to obtain a desired image, which includes highlights and shadows that have gradation. Hence, the operation for adjusting the image quality is extremely troublesome for the user.

### SUMMARY OF THE INVENTION

In view of the foregoing circumstances, it is an object of the present invention to make it possible to easily perform operation for adjusting a correction amount of a dynamic range.

An image processing apparatus of the present invention is an image processing apparatus, wherein processed image data is obtained by performing predetermined image processing on image data representing an image, the apparatus comprising:

a correction amount calculation means for calculating a recommended correction amount for compressing the dynamic range of the image;

an instruction means for giving an instruction on a desired correction amount of the dynamic range; and

a display means for displaying information representing the recommended correction amount.

Further, the image processing apparatus of the present invention may further comprise a conversion means for converting the recommended correction amount into the number of times of operation of the instruction means, the number of times of operation being necessary to correct the dynamic range by the recommended correction amount. Further, the display means may display the number of times of operation as information representing the recommended correction amount.

Further, in the image processing apparatus of the present invention, the display means may display information representing the recommended correction amount together with a histogram of the image data.

Further, in the image processing apparatus of the present invention, if the image includes a saturated area, the display means may display the image in such a manner that the saturated area can be visually recognized. Further, the display means may display information representing the recommended correction amount in such a manner that the recommended correction amount corresponds to the saturated area.

The term “saturated area” refers to an area in which the density range of the image exceeds the reproduction range of a reproduction apparatus. The saturated area is a white area in a highlight (an area in which gradation is lost by so-called “Shiro-Tobi” in Japanese) and/or a black area in a shadow (an area in which gradation is lost by so-called “Kuro-Tsubure” in Japanese).

Further, in the image processing apparatus of the present invention, if the image includes a saturated area that cannot be corrected, the display means may display the image in such a manner that the saturated area that cannot be corrected can be visually recognized.

The phrase “saturated area that cannot be corrected” refers to an area, of which the gradation cannot be regenerated even if the dynamic range of the image is compressed. The saturated area that cannot be corrected is an area of a highlight and/or shadow of the image, the area having no gradation, because the image has been obtained in an overexposure or underexposure state or the like, for example.

An image processing method of the present invention is an image processing method, wherein processed image data is obtained by performing predetermined image processing on image data representing an image, the method comprising the steps of:

calculating a recommended correction amount for compressing the dynamic range of the image; and

displaying information representing the recommended correction amount.

Further, the image processing method of the present invention may be provided as a program for causing a computer to execute the image processing method or as a computer-readable recording medium having stored therein the program.

According to the present invention, a recommended correction amount for compressing the dynamic range of an image is calculated. Further, information representing the calculated recommended correction amount is displayed. Therefore, a user can visually recognize the recommended correction amount of the dynamic range. Consequently, the user can easily correct the dynamic range based on the displayed recommended correction amount in such a manner that the taste of the user is reflected. Hence, it is possible to reduce operation time for adjusting the correction amount of the dynamic range.

Further, the recommended correction amount is converted into the number of times of operation at an instruction means, the number of times of operation being necessary to correct the dynamic range by the recommended correction amount. Further, the number of times of operation is displayed as information representing the correction amount. Therefore, the user can recognize the correction amount in form of the number of times of operation at the instruction means. Therefore, the user can more easily correct the dynamic range.

Further, since the information representing the recommended correction amount is displayed together with a histogram of image data, the user can easily recognize how much the dynamic range should be corrected.

Further, a saturated area included in an image is displayed in such a manner that the saturated area can be visually recognized. Further, information representing a recommended correction amount is displayed so as to correspond to the saturated area. Therefore, it is possible to easily recognize the saturated area included in the image. Hence, it is possible to correct the dynamic range so that the saturated area has appropriate gradation.

In this case, if the image includes a saturated area that cannot be corrected, the saturated area that cannot be corrected should be displayed in such a manner that the saturated area that cannot be corrected can be visually recognized. Since a user knows that the saturated area that cannot be corrected is an area of which the gradation is not changed even if the dynamic range is corrected and the user can recognize the saturated area that cannot be corrected, it is possible to prevent the user from performing useless adjustment operation on the saturated area that cannot be corrected.

Note that the program of the present invention may be provided being recorded on a computer-readable recording medium. Those who are skilled in the art would know that computer-readable recording media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also within the scope of this invention. Additionally, computer instructions include, but are not limited to: source, object and executable code, and can be in any language including higher level languages, assembly language, and machine language.

### BRIEF DESCRIPTION OF THE DRAWINGS

FIG. 1 is a schematic block diagram illustrating the configuration of an image processing apparatus in an embodiment of the present invention;

FIG. 2 is a histogram showing the brightness of processed image data (No. 1);

FIG. 3 is a diagram illustrating an examination screen;

FIG. 4 is a flow chart showing processing performed in the embodiment of the present invention;

FIG. 5 is a histogram showing the brightness of processed image data (No. 2);

FIG. 6 is a diagram illustrating a manner in which a processed image is displayed.

### DESCRIPTION OF THE PREFERRED EMBODIMENTS

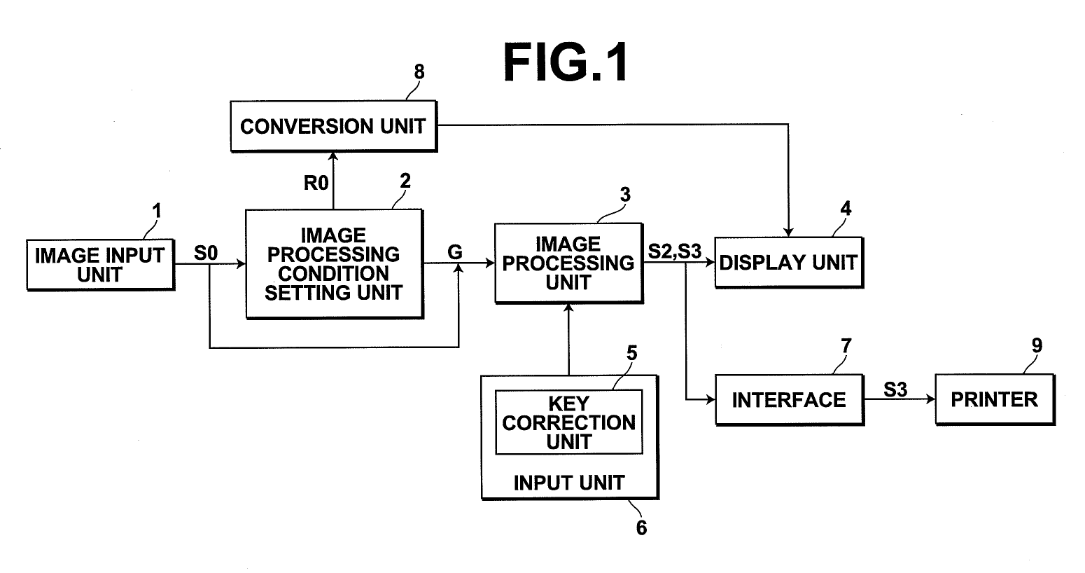

Hereinafter, embodiments of the present invention will be described with reference to the attached drawings. FIG. 1 is a schematic block diagram illustrating the configuration of an image processing apparatus according to an embodiment of the present invention. As illustrated in FIG. 1, the image processing apparatus of the present embodiment includes an image input unit 1, an image processing condition setting unit 2, an image processing unit 3, a display unit 4, an input unit 6 including a key correction unit 5, an interface 7 and a conversion unit 8. The image input unit 1 receives input of image data S0 representing a color image, and the image data S0 includes color data of each of RGB. The image processing condition setting unit 2 sets image processing condition G for performing image processing on the image data S0. The image processing unit 3 obtains processed image data S2 by performing image processing on the image data S0. The image processing unit 3 performs image processing based on the image processing condition G set by the image processing condition setting unit 2 and an instruction from the key correction unit 5, which will be described later in detail. The display unit 4 is a unit, such as a monitor, for regenerating (reproducing) the processed image data S2. The interface 7 is provided to output processed image data S3, which is finally obtained, to a printer. The conversion unit 8 converts a correction amount of a dynamic range, which will be described later, into the number of times of operation of a key at the key correction unit 5.

The image input unit 1 includes a medium drive for reading out image data S0 stored in a medium therefrom and various kinds of interfaces for receiving image data S0 that has been sent through a network. The image data S0 may be obtained with a photography apparatus (imaging apparatus), such as a digital camera. Alternatively, the image data S0 may be obtained by photoelectrically reading out an image recorded on film or a document.

The image processing condition setting unit 2 generates a histogram of brightness based on image data S0. Further, the image processing condition setting unit 2 calculates the characteristic values (feature values) of an image, such as the highest density (lowest brightness), the lowest density (highest brightness) and an average density. Then, the image processing condition setting unit 2 sets an image processing condition. Specifically, the image processing condition setting unit 2 sets image processing condition G by calculating a density correction amount for correcting density, a color correction amount for correcting color, a dynamic range correction amount for correcting a dynamic range, a degree of emphasis for performing sharpness processing and the like. When the image processing condition G is set, a photography condition, such as presence of strobe light and an exposure value, at the time of obtainment of the image data S0 may be taken into consideration in addition to the characteristic values of the image data S0.

The density range of an image represented by the image data S0 is usually wider than the reproduction range of density in a print. For example, if a picture is taken against light or with strobe light, the density range (a difference between the lowest density and the highest density, in other words, a dynamic range) of the image obtained by photography may significantly exceed the reproduction range of density in a print in some cases. In such a case, it is impossible to regenerate all of the image data (pixels) in a print. A light area (highlight) of the subject of photography exceeding the reproduction range is reproduced as a white area (an area in which gradation is lost by so-called “Shiro-Tobi” in Japanese) in the print, and a dark area (shadow) of the subject exceeding the reproduction range is reproduced as a black area (an area in which gradation is lost by so-called “Kuro-Tsubure” in Japanese). Therefore, if all of the image data S0 needs to be regenerated in the print, it is necessary to compress the dynamic range of the image data S0 into a range corresponding to the reproduction range of density in the print. Hence, the image processing condition setting unit 2 calculates, as a correction amount R0 of the dynamic range, a correction amount by which the dynamic range needs to be compressed. The dynamic range is compressed by adjusting the density in the highlight and the shadow without changing gradation in the intermediate density range.

The image processing unit 3 generates processed image data S2 by performing image processing on image data S0 based on image processing condition G set by the image processing condition setting unit 2 except the correction amount R0 of the dynamic range. Therefore, the processed image data S2 is data of which the dynamic range has not be corrected.

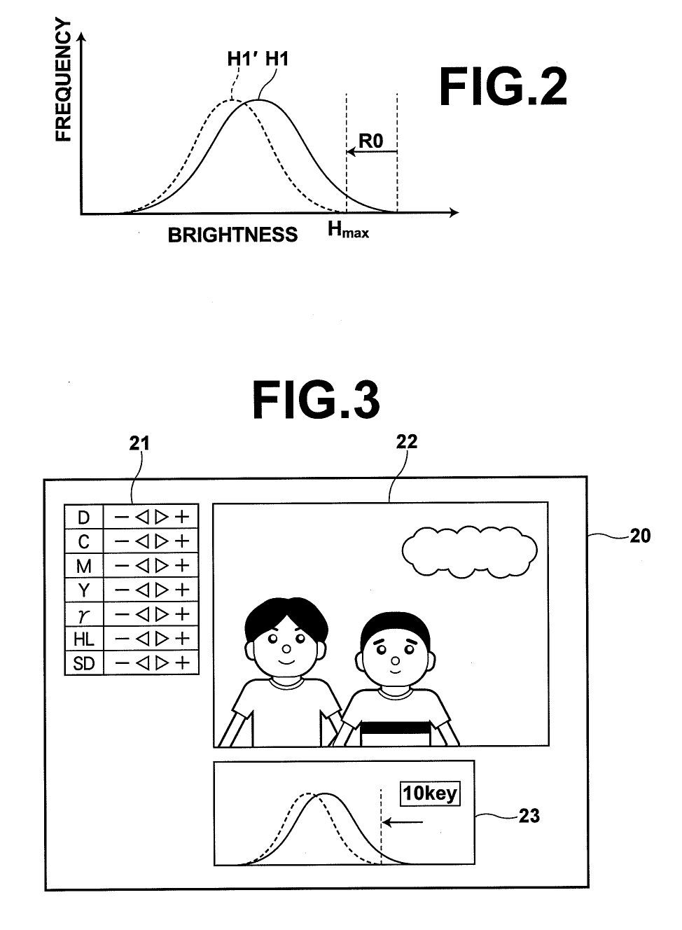

FIG. 2 is a diagram illustrating a histogram of the brightness of processed image data S2, generated by performing the image processing except the dynamic range compression processing. In FIG. 2, Hmax is the highest brightness (in other words, lowest density) on the highlight side, which can be reproduced at the printer 9. As illustrated in FIG. 2, a highlight portion of histogram H1 of brightness exceeds highest brightness Hmax that can be reproduced by the printer 9. Therefore, loss of gradation by so-called “Shiro-Tobi” in Japanese occurs in the highlight portion. Therefore, it is necessary to correct the dynamic range by the correction amount R0 so that the brightness range of the histogram H1 of brightness becomes within the reproduction range of the printer 9, as indicated by histogram H1′ of brightness.

The conversion unit 8 converts the correction amount R0 into the number of times of key operation at the key correction unit 5 that is necessary to correct the dynamic range by the correction amount R0. For example, if the correction amount R0 of the dynamic range is 15 in the histogram H1 of brightness, and if a correction amount in each key operation of the key correction unit 5 is 1.5, the conversion unit 8 converts the correction amount R0 into 10, which is the number of times of operation necessary to correct the dynamic range by the correction amount R0.

The key correction unit 5 forms a part of the input unit 6 including a keyboard and a mouse, for example. The key correction unit 5 is operated by an operator when the operator adjusts the image quality using an examination screen displayed on the display unit 4. FIG. 3 is a diagram illustrating the examination screen. As illustrated in FIG. 3, a correction key 21, a display area 22 of the processed image S2 (hereinafter, the same reference numeral as that of image data is used for the image) and a display area 23 of a histogram are displayed in the examination screen 20. The display area 22 displays the processed image S2 represented by the processed image data S2. The display area 23 displays the histogram of the brightness of the processed image data S2.

The correction key 21 can correct each of the density (D) of the whole image, the density of cyan (C), the density of magenta (M), the density of yellow (Y), gradation (y), highlight (HL) portions and shadow (SD) portions, for example.

The display area 22 displays the processed image S2, represented by the processed image data S2.

The display area 23 of a histogram displays the histogram H1 of the brightness of the processed image data S2 and the number of times of key operation that is necessary to correct the dynamic range by the correction amount R0. The number of times of key operation is a number into which the correction amount R0 has been converted by the conversion unit 8. In this example, “10 key” is displayed as the number.

The operator operates the key correction unit 5, looking at the examination screen, and adjusts the image S2 so that the image S2 has a desirable quality.

The image processing unit 3 generates new processed image data S2 at each time when the operator performs key operation. The new processed image data is generated by performing, based on image processing condition G changed by the image processing condition setting unit 22, image processing on image data S0. The processed image data S2 is displayed on the display unit 4.

Then, when the quality of the image S2 reaches a desired level, the operator inputs an instruction to print out at the input unit 6. Accordingly, final processed image data S3 is sent to the printer 9 through the interface 7 and output as a print at the printer 9.

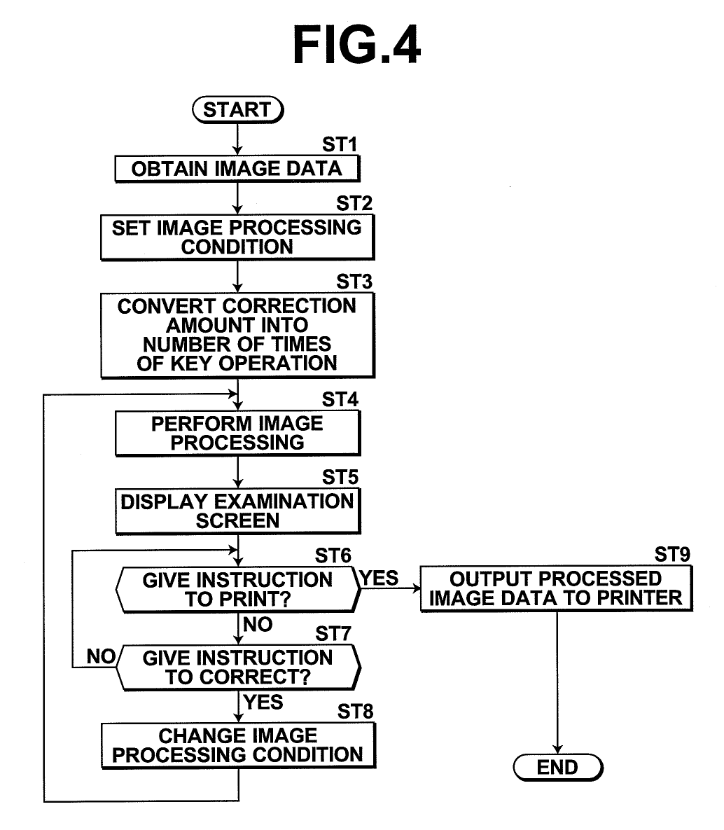

Next, processing in the present embodiment will be described. FIG. 4 is a flow chart of the processing performed in the present embodiment. When a user gives an instruction to perform input of an image, the image input unit 1 starts processing and obtains image data S0 (step ST1). Then, the image processing condition setting unit 2 sets image processing condition G (step ST2). Further, the conversion unit 8 converts a correction amount R0 of the dynamic range, the correction amount R0 being included in the image processing condition G, into the number of times of key operation by the key correction unit 5 (step ST3) . Then, the image processing unit 3 generates processed image data S2 by performing image processing on the image data S0 (step ST4).

Then, the display unit 4 displays an examination screen of the processed image data S2 (step ST5). Further, the image processing unit 3 judges whether an instruction to print has been given (step ST6). If step ST6 is NO, judgment is made as to whether the user has input a correction instruction at the key correction unit 5 (step ST7). If step ST7 is YES, the image processing condition setting unit 2 changes the image processing condition G based on the key operation amount (step ST8). Then, the processing goes back to step ST4, and the processing in and after step ST4 is repeated. If step ST7 is NO, processing goes back to step ST6.

If step ST6 is YES, processed image data S3, which has been finally obtained, is output to the printer 9 through the interface 7 (step ST9), and processing ends. Accordingly, the processed image data S3 is printed at the printer 9.

As described above, in the present embodiment, the number of times of key operation that is necessary to correct the dynamic range by the correction amount R0, which has been calculated by the image processing condition setting unit 2, is displayed. Therefore, the user can have a rough idea (rough indication or rough guide) of the recommended correction amount of the dynamic range by looking at the displayed number of times of key operation. Consequently, the user can correct the dynamic range based on the displayed correction amount so that his/her taste is reflected in the processed image. Therefore, it is possible to reduce operation time for adjusting the correction amount of the dynamic range.

Further, since the number of times of key operation is displayed together with the histogram of the image data, it is possible to easily recognize approximately how many times of key operation should be done.

In the above embodiment, the correction amount R0 of the dynamic range is calculated so that the loss of gradation (“Shiro-Tobi”) in the highlight is prevented. Alternatively, when a picture of a subject is taken against light, loss of gradation (“Kuro-Tsubure”) in a shadow of the subject may occur. If image data S0 of such an image is a processing object, the correction amount R0 of the dynamic range is calculated so that the loss of gradation in the shadow is prevented.

Further, in the above embodiment, the correction amount R0 of the dynamic range is calculated so that the dynamic range becomes within the reproduction range of the printer. Alternatively, a compression amount for changing the density range of the processed image data S2 to the reproduction range of the image data S0 may be calculated as a correction amount R0 of the dynamic range. For example, as illustrated in FIG. 5, if the processed image data S2 has been shifted from the image data S0 toward the high brightness side by image processing, the correction amount R0 of the dynamic range may be calculated so that the highest brightness in the histogram H1 of the processed image data S2 becomes the same as the highest brightness in histogram H2 of the image data S0. In contrast, if the processed image data S2 has been shifted from the image data S0 toward the low brightness side by image processing, the correction amount R0 of the dynamic range may be calculated so that the lowest brightness in the histogram H1 of the processed image data S2 becomes the same as the lowest brightness in histogram H2 of the image data so.

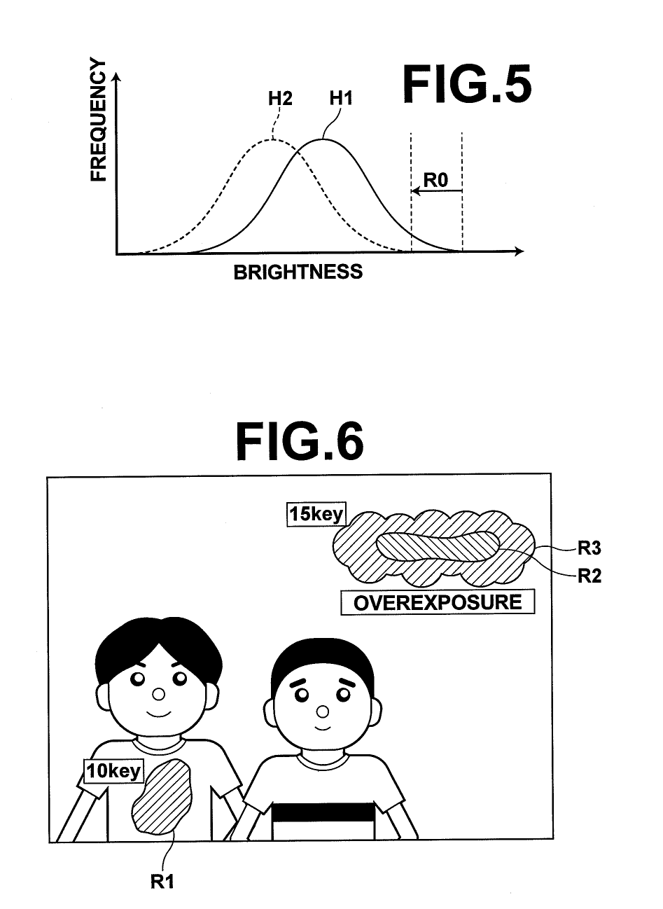

Further, in the above embodiment, in the processed image S2 displayed in the display area 22, an area in which the density exceeds the reproduction range of density, in other words, an area in which gradation is lost by so-called “Shiro-Tobi” and/or “Kuro-Tsubure” may be displayed so that such an area can be visually recognized. For example, when an image includes two persons and a cloud, as illustrated in FIG. 6, if so-called “Shiro-Tobi”, formation of a white area in which gradation is lost, has occurred in a part of the clothes of a person on the left side and a part of the cloud, areas R1 and R2, in which the “Shiro-Tobi” has occurred, may be displayed in red, for example. In FIG. 6, the areas R1 and R2 are indicated with shading. In this case, it is desirable that the numbers of times of key operation necessary to correct the dynamic ranges are displayed in such manner that they correspond to areas R1 and R2, respectively.

Meanwhile, if so-called “Shiro-Tobi” and/or “Kuro-Tsubure” is already present in image data S0, even if the dynamic range is corrected, it is impossible to regenerate gradation in the area in which the “Shiro-Tobi” and/or “Kuro-Tsubure” is present. Therefore, such an area may be displayed so that it is possible to visually recognize that the area is an area in which correction is impossible. For example, in the image illustrated in FIG. 6, if area R3 surrounding the area R2 in the cloud is an area in which “Shiro-Tobi” has been present by overexposure even before image processing, in other words, if area R3 is an area in which correction is impossible, the area R3 may be displayed in blue, for example. Further, “OVEREXPOSURE” may be displayed so as to correspond to the area R3.

Further, in the above embodiment, the number of times of key operation necessary to correct the dynamic range by the correction amount R0 is displayed. Alternatively, the correction amount R0 of the dynamic range, itself, may be displayed.

The apparatus according to the embodiment of the present invention has been described. It is also possible to cause a computer to function as means corresponding to the image processing condition setting unit 2, the image processing unit 3 and the conversion unit 8 to perform the steps illustrated in the flow chart of FIG. 4. A program for causing the computer to perform the steps illustrated in FIG. 4 is another embodiment of the present invention. Further, a computer-readable recording medium stored therein such a program is another embodiment of the present invention. Such a program may be integrated into viewer software for viewing images.

What is claimed is:

1. An image processing apparatus, wherein processed image data is obtained by performing predetermined image processing on image data representing an image, the apparatus comprising:
a correction amount calculation means for calculating a recommended correction amount for compressing the dynamic range of the image;
an instruction means for giving an instruction on a desired correction amount of the dynamic range; and
a display means for displaying information representing the recommended correction amount.

2. An image processing apparatus, as defined in claim 1, further comprising:
a conversion means for converting the recommended correction amount into the number of times of operation of the instruction means, the number of times of operation being necessary to correct the dynamic range by the recommended correction amount, wherein the display means displays the number of times of operation as information representing the recommended correction amount.

3. An image processing apparatus, as defined in claim 1, wherein the display means displays information representing the recommended correction amount together with a histogram of the image data.

4. An image processing apparatus, as defined in claim 1, wherein if the image includes a saturated area, the display means displays the image in such a manner that the saturated area can be visually recognized and displays information representing the recommended correction amount in such a manner that the recommended correction amount corresponds to the saturated area.

5. An image processing apparatus, as defined in claim 4, wherein if the image includes a saturated area that cannot be corrected, the display means displays the image in such a manner that the saturated area that cannot be corrected can be visually recognized.

6. An image processing method, wherein processed image data is obtained by performing predetermined image processing on image data representing an image, the method comprising the steps of:
calculating a recommended correction amount for compressing the dynamic range of the image; and
displaying information representing the recommended correction amount.

7. A computer-readable recording medium having stored therein a program that causes a computer to execute an image processing method, wherein processed image data is obtained by performing predetermined image processing on image data representing an image, the program comprising the procedures for:
calculating a recommended correction amount for compressing the dynamic range of the image; and
displaying information representing the recommended correction amount.

8. An image processing apparatus, wherein processed image data is obtained by performing predetermined image processing on image data representing an image, the apparatus comprising:
a correction amount calculation unit for calculating a recommended correction amount for compressing the dynamic range of the image;
an instruction unit for giving an instruction on a desired correction amount of the dynamic range; and
a display unit for displaying information representing the recommended correction amount.
